(19) United States
(12) Patent Application Publication
(10) Pub. No.: US 2026/0159144 A1
(43) Pub. Date: Jun. 11, 2026

(54) MOVABLE FOLDING HANDCART

(71) Applicant: Anhui Hope Pet Products Co.,Ltd., Hefei (CN)

(72) Inventors: Bobo Gu, Hefei (CN); Jun Ye, Hefei (CN)

(21) Appl. No.: 19/026,360

(22) Filed: Jan. 17, 2025

(30) Foreign Application Priority Data
Dec. 10, 2024 (CN) 202423040853.6

(51) Int. Cl. B62B 3/02

(52) U.S. Cl. CPC B62B 3/02

(57) ABSTRACT

The present disclosure relates to the technical field of handcarts, and a movable folding handcart is disclosed, including a cart base plate. A rear support assembly is fixedly mounted at two ends of one side of an upper end of the cart base plate, and a main connecting assembly is movably mounted at middle parts of two sides of an outer wall of the cart base plate. Being movably mounted on two sides of an inner wall of a third U-shaped round rod, a driven assembly tilts forwards along with the third U-shaped round rod. In a case that a lower end of the third U-shaped round rod comes into contact with the upper end of the cart base plate, the handcart is folded and stored, favoring carrying when the folding cart is not in use.

### CROSS-REFERENCE TO RELATED APPLICATION

This application claims priority of Chinese Patent Application No. 202423040853.6, filed on Dec. 10, 2024, the entire contents of which are incorporated herein by reference.

### TECHNICAL FIELD

The present disclosure relates to the technical field of handcarts, and specifically to a movable folding handcart.

### BACKGROUND

A handcart is a handling vehicle that is pushed or pulled by human power. Typically, pulleys are mounted at four corners of a lower end of a cart plate, and the cart plate is driven to move by means of the pulleys. Currently, pets are taken outdoors mainly through leashes or by manual carrying. However, it is more strenuous for manually carrying large pets, with inconvenient movement. Placing large pets on a handcart allows for direct carrying, which is more effortless and convenient compared to manual carrying.

Currently, due to a fixed size, the handcart occupies more space when stored or placed by a user. Additionally, it is inconvenient for the user to carry the handcart due to its fixed usage space.

Therefore, a movable folding handcart is provided to address the problems raised above.

### SUMMARY

An objective of the present disclosure is to provide a movable folding handcart, to solve the problems raised in the background that, due to a fixed size, the handcart occupies more space when stored or placed by a user, and it is inconvenient for the user to carry the handcart due to its fixed usage space.

To realize the above objective, the present disclosure provides the following technical solutions. A movable folding handcart includes a cart base plate, and first sliding wheels fixedly mounted at two ends of one side of a lower end of the cart base plate. A bracket is fixedly mounted at two ends of the other side of the lower end of the cart base plate, second sliding wheels being arranged at two ends of the bracket, a rear support assembly is fixedly mounted at two ends of one side of an upper end of the cart base plate, and a main connecting assembly is movably mounted at middle parts of two sides of an outer wall of the cart base plate, a driven assembly being movably mounted on one side of an upper end of the rear support assembly.

Preferably, the rear support assembly includes concave brackets, and a first U-shaped round rod movably mounted via a movable shaft, a second U-shaped round rod being movably mounted on one side of an inner wall of the concave bracket, and first internal threaded slot rods being fixedly mounted at two ends of one side of a lower end of the second U-shaped round rod.

Preferably, hinge blocks are fixedly mounted on two sides of middle parts of an outer wall of the first U-shaped round rod, a third U-shaped round rod being movably mounted on one side of the hinge block, a second internal threaded slot rod being fixedly mounted at a middle part of one end of an outer wall of the third U-shaped round rod, and a first hollow clamping block being fixedly mounted at a middle part of an upper end of the first U-shaped round rod.

Preferably, the main connecting assembly includes a pushing mechanism and support mechanisms movably mounted on two sides of a lower end of the pushing mechanism, a right-angle block being movably mounted at a lower end of each of the support mechanisms, and a diagonal support rod being movably mounted on one side of an upper end of the right-angle block.

Preferably, the pushing mechanism includes a fifth U-shaped round rod, and first hollow round sleeve columns fixedly mounted on two sides of a lower end of the fifth U-shaped round rod, a first half-section circular block being integrally formed at a lower end of each of the first hollow round sleeve columns, and an insertion rod being fixedly mounted at a middle part of an inner cavity of the first half-section circular block.

Preferably, each of the support mechanisms includes a long rod and a second hollow round sleeve column fixedly mounted at one end of the long rod, a corresponding half-section circular block being fixedly mounted at one end of the second hollow round sleeve column, and a circular annular groove being mounted at a middle part of an inner cavity of the corresponding half-section circular block.

Preferably, the driven assembly includes a fourth U-shaped round rod, and a sixth U-shaped round rod movably mounted on two sides of one end of the fourth U-shaped round rod, convex blocks being movably mounted on two sides of a lower end of the sixth U-shaped round rod, and a second hollow clamping block being fixedly mounted at a middle part of one end of the fourth U-shaped round rod.

Compared with the prior art, the present disclosure has the following advantageous effects.
1. When the handcart is not in use, by pressing the fifth U-shaped round rod towards a front lower end, the first half-section circular block at one end of the fifth U-shaped round rod and the corresponding half-section circular block rotate, causing the long rod to be folded towards a front end. Simultaneously, when the long rod is folded towards the front end, the diagonal support rod movably mounted is driven to tilt forwards, causing the diagonal support rod to drive the first U-shaped round rod and the third U-shaped round rod to tilt forwards. Being movably mounted on two sides of the inner wall of the third U-shaped round rod, the driven assembly tilts forwards along with the third U-shaped round rod. In a case that the lower end of the third U-shaped round rod comes into contact with the upper end of the cart base plate, the handcart is folded and stored, favoring carrying when the folding cart is not in use.
2. When the pet needs to get off, a T-shaped screw threadedly connected to the inner cavity of the first internal threaded slot rod can be loosened, allowing the first hollow clamping block to be removed from one end of the first internal threaded slot rod. Since two sides of one end of the second U-shaped round rod are movably mounted at one end of the inner wall of the concave bracket, the other end of the second U-shaped round rod is in contact with the ground, enabling the pet to get off from the second U-shaped round rod, with a convenient use.

### BRIEF DESCRIPTION OF THE DRAWINGS

FIG. 1 is a schematic diagram of an overall three-dimensional structure of the present disclosure;

FIG. 2 is a schematic diagram of a three-dimensional structure of a rear support assembly, a main connecting assembly, and a driven assembly of the present disclosure;

FIG. 3 is a schematic diagram of a three-dimensional structure of a pushing mechanism of the present disclosure; and

FIG. 4 is a schematic diagram of a three-dimensional structure of a support mechanism of the present disclosure.

Reference numerals and denotations thereof: 1—cart base plate; 2—first sliding wheel; 3—bracket; 4—second sliding wheel; 5—rear support assembly; 51—concave bracket; 52—first U-shaped round rod; 53—second U-shaped round rod; 54—first internal threaded slot rod; 55—hinge block; 56—third U-shaped round rod; 57—second internal threaded slot rod; 58—first hollow clamping block; 6—main connecting assembly; 61—pushing mechanism; 611—fifth U-shaped round rod; 612—first hollow round sleeve column; 613—first half-section circular block; 614—insertion rod; 62—support mechanism; 621—long rod; 622—second hollow round sleeve column; 623—corresponding half-section circular block; 624—circular annular groove; 63—right-angle block; 64—diagonal support rod; 7—driven assembly; 71—fourth U-shaped round rod; 72—sixth U-shaped round rod; 73—convex block; and 74—second hollow clamping block.

### DETAILED DESCRIPTION

The technical solutions of the examples in the present disclosure will be described clearly and completely by reference to the accompanying drawings of the examples in the present disclosure below. Obviously, the examples described are only some, rather than all examples of the present disclosure. Based on the examples of the present disclosure, all the other examples obtained by the ordinary skilled in the art without creative effort belong to the protection scope of the present disclosure.

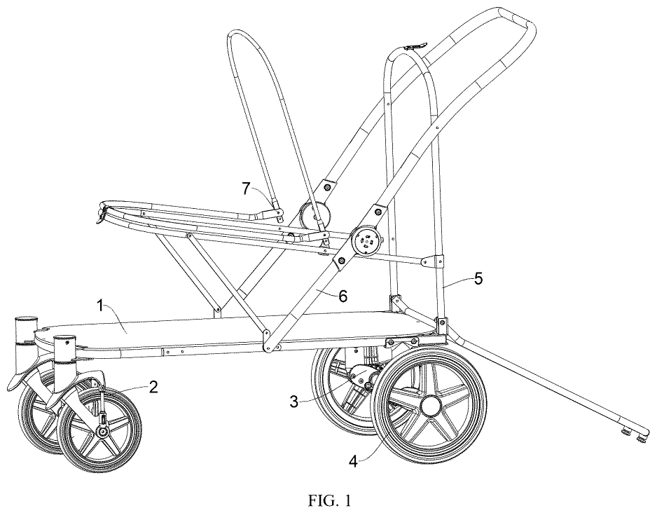

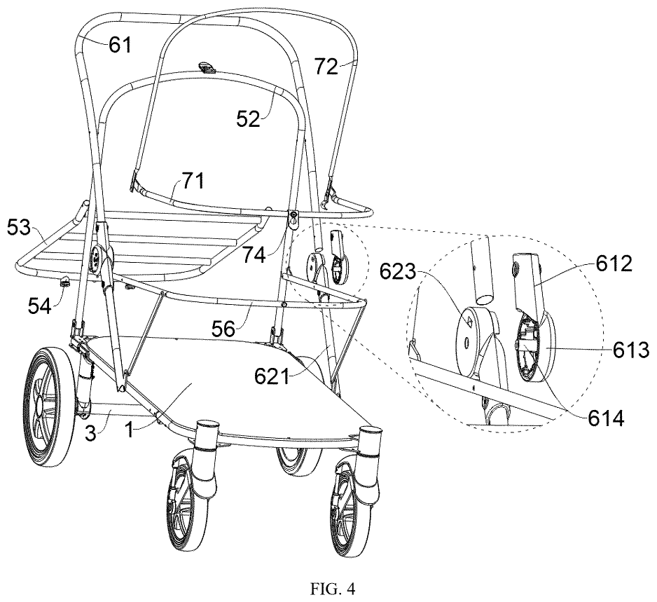

Example one: referring to FIG. 1 to FIG. 4, a movable folding handcart includes a cart base plate 1, and first sliding wheels 2 fixedly mounted at two ends of one side of a lower end of the cart base plate 1. A bracket 3 is fixedly mounted at two ends of the other side of the lower end of the cart base plate 1, and second sliding wheels 4 are arranged at two ends of the bracket 3. The arrangement of the first sliding wheel 2 and the second sliding wheel 4 is suitable for driving the cart base plate 1 to move. A rear support assembly 5 is fixedly mounted at two ends of one side of an upper end of the cart base plate 1, and a main connecting assembly 6 is movably mounted at middle parts of two sides of an outer wall of the cart base plate 1, a driven assembly 7 being movably mounted on one side of an upper end of the rear support assembly 5.

The main connecting assembly 6 includes a pushing mechanism 61 and support mechanisms 62 movably mounted on two sides of a lower end of the pushing mechanism 61. A right-angle block 63 is movably mounted at a lower end of each of the support mechanisms 62, and the right-angle block 63 is fixedly mounted on two sides of middle parts of the outer wall of the cart base plate 1, so that the lower end of the support mechanism 62 is movably mounted on two sides of middle parts of the outer wall of the cart base plate 1. A diagonal support rod 64 is movably mounted on one side of an upper end of the right-angle block 63, and an upper end of the diagonal support rod 64 and two sides of an outer wall of the third U-shaped round rod 56 are mounted movably.

The pushing mechanism 61 includes a fifth U-shaped round rod 611, and first hollow round sleeve columns 612 fixedly mounted on two sides of a lower end of the fifth U-shaped round rod 611, a first half-section circular block 613 being integrally formed at a lower end of each of the first hollow round sleeve columns 612, and an insertion rod 614 being fixedly mounted at a middle part of an inner cavity of the first half-section circular block 613.

Each of the support mechanisms 62 includes a long rod 621 and a second hollow round sleeve column 622 fixedly mounted at one end of the long rod 621, a corresponding half-section circular block 623 being fixedly mounted at one end of the second hollow round sleeve column 622, a circular annular groove 624 being mounted at a middle part of an inner cavity of the corresponding half-section circular block 623, and the insertion rod 614 being movably mounted in an inner cavity of the circular annular groove 624, so that the first half-section circular block 613 and the corresponding half-section circular block 623 are mounted movably.

The driven assembly 7 includes a fourth U-shaped round rod 71 and a sixth U-shaped round rod 72 movably mounted on two sides of one end of the fourth U-shaped round rod 71, convex blocks 73 being movably mounted on two sides of a lower end of the sixth U-shaped round rod 72, and a second hollow clamping block 74 being fixedly mounted at a middle part of one end of the fourth U-shaped round rod 71. The second internal threaded slot rod 57 is movably mounted in the inner cavity of the second hollow clamping block 74 and is threadedly connected to the inner cavity of the second internal threaded slot rod 57 via screws, thereby securing the upper end of the second hollow clamping block 74 and simultaneously completing the connection between the fourth U-shaped round rod 71 and the third U-shaped round rod 56.

In this example: when the handcart is not in use, by pressing the fifth U-shaped round rod 611 towards a front lower end, the first half-section circular block 613 at one end of the fifth U-shaped round rod 611 and the corresponding half-section circular block 623 rotate, causing the long rod 621 to be folded towards a front end (the direction of the first sliding wheel 2). Simultaneously, when the long rod 621 is folded towards the front end, the diagonal support rod 64 movably mounted is driven to tilt forwards, causing the diagonal support rod 64 to drive the first U-shaped round rod 52 and the third U-shaped round rod 56 to tilt forwards. Being movably mounted on two sides of the inner wall of the third U-shaped round rod 56, the driven assembly 7 tilts forwards along with the third U-shaped round rod 56. In a case that the lower end of the third U-shaped round rod 56 comes into contact with the upper end of the cart base plate 1, the handcart is folded and stored, favoring carrying when the folding cart is not in use.

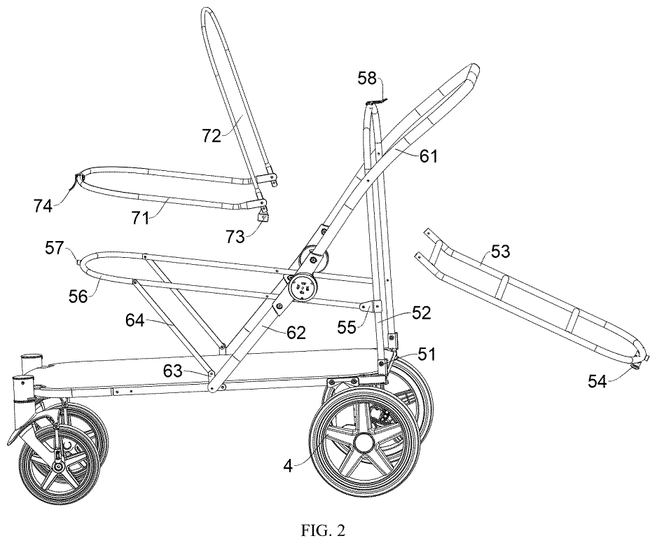

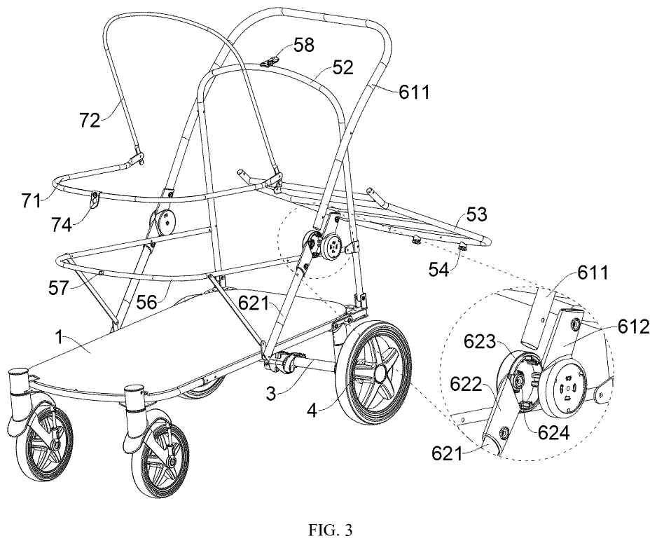

Example two: this example is improved based on Example 1. Specifically, referring to FIG. 2 to FIG. 3, the rear support assembly 5 includes concave brackets 51, and a first U-shaped round rod 52 movably mounted via a movable shaft. A second U-shaped round rod 53 is movably mounted on one side of an inner wall of the concave bracket 51, and a bottom of the second U-shaped round rod 53 rotates on an inner side of the concave bracket 51. First internal threaded slot rods 54 are fixedly mounted at two ends of one side of a lower end of the second U-shaped round rod 53, and the second U-shaped round rod 53 forms a gentle slope for the pet standing on the upper end of the cart base plate 1 to get off.

Hinge blocks 55 are fixedly mounted on two sides of middle parts of an outer wall of the first U-shaped round rod 52, and a third U-shaped round rod 56 is movably mounted on one side of the hinge block 55. A second internal threaded slot rod 57 is fixedly mounted at a middle part of one end of an outer wall of the third U-shaped round rod 56, and a first hollow clamping block 58 is fixedly mounted at a middle part of an upper end of the first U-shaped round rod 52. The first internal threaded slot rod 54 is movably mounted in an inner cavity of the first hollow clamping block 58 and is threadedly mounted in an inner cavity of the first internal threaded slot rod 54 via a T-shaped screw, thereby completing the connection between the second U-shaped round rod 53 and the first hollow clamping block 58.

In this example: after placing the pet on the upper end of the cart base plate 1, the main connecting assembly 6 is pushed to drive the entire handcart to move. When the pet needs to get off, the T-shaped screw threadedly connected to the inner cavity of the first internal threaded slot rod 54 can be loosened, allowing the first hollow clamping block 58 to be removed from one end of the first internal threaded slot rod 54. Since two sides of one end of the second U-shaped round rod 53 are movably mounted at one end of the inner wall of the concave bracket 51, the other end of the second U-shaped round rod 53 can make contact with the ground, enabling the pet to get off from the second U-shaped round rod 53, with continent use.

An operation principle is as follows. After placing the pet on the upper end of the cart base plate 1, the main connecting assembly 6 is pushed to drive the entire handcart to move. When the pet needs to get off, the T-shaped screw threadedly connected to the inner cavity of the first internal threaded slot rod 54 can be loosened, allowing the first hollow clamping block 58 to be removed from one end of the first internal threaded slot rod 54. Since two sides of one end of the second U-shaped round rod 53 are movably mounted at one end of the inner wall of the concave bracket 51, the other end of the second U-shaped round rod 53 can make contact with the ground, enabling the pet to get off from the second U-shaped round rod 53. When the handcart is not in use, by pressing the fifth U-shaped round rod 611 towards a front lower end, the first half-section circular block 613 at one end of the fifth U-shaped round rod 611 and the corresponding half-section circular block 623 rotate, causing the long rod 621 to be folded towards a front end (the direction of the first sliding wheel 2). Simultaneously, when the long rod 621 is folded towards the front end, the diagonal support rod 64 movably mounted is driven to tilt forwards, causing the diagonal support rod 64 to drive the first U-shaped round rod 52 and the third U-shaped round rod 56 to tilt forwards. Being movably mounted on two sides of the inner wall of the third U-shaped round rod 56, the driven assembly 7 tilts forwards along with the third U-shaped round rod 56. In a case that the lower end of the third U-shaped round rod 56 comes into contact with the upper end of the cart base plate 1, the handcart is folded and stored.

The second hollow round sleeve column 622, the corresponding half-section circular block 623, the circular annular groove 624, the first hollow round sleeve column 612, the first half-section circular block 613, and the insertion rod 614 together form a locking large joint, with the model being HP-716.

The content not described in detail in the specification belongs to the prior art known to those skilled in the art.

Although the present disclosure is described in detail by reference to the examples mentioned above, for those skilled in the art, the technical solutions recorded in the examples mentioned above can be modified or some of the technical features thereof can be replaced equivalently. Any modifications, equivalent replacements, improvements, etc., are included in the scope of protection of the present disclosure.

1. A movable folding handcart, comprising a cart base plate (1), and first sliding wheels (2) fixedly mounted at two ends of one side of a lower end of the cart base plate (1), wherein a bracket (3) is fixedly mounted at two ends of the other side of the lower end of the cart base plate (1), second sliding wheels (4) being arranged at two ends of the bracket (3), a rear support assembly (5) is fixedly mounted at two ends of one side of an upper end of the cart base plate (1), and a main connecting assembly (6) is movably mounted at middle parts of two sides of an outer wall of the cart base plate (1), a driven assembly (7) being movably mounted on one side of an upper end of the rear support assembly (5).

2. The movable folding handcart according to claim 1, wherein the rear support assembly (5) comprises concave brackets (51), and a first U-shaped round rod (52) movably mounted via a movable shaft, a second U-shaped round rod (53) being movably mounted on one side of an inner wall of the concave bracket (51), and first internal threaded slot rods (54) being fixedly mounted at two ends of one side of a lower end of the second U-shaped round rod (53).

3. The movable folding handcart according to claim 2, wherein hinge blocks (55) are fixedly mounted on two sides of middle parts of an outer wall of the first U-shaped round rod (52), a third U-shaped round rod (56) being movably mounted on one side of the hinge block (55), a second internal threaded slot rod (57) being fixedly mounted at a middle part of one end of an outer wall of the third U-shaped round rod (56), and a first hollow clamping block (58) being fixedly mounted at a middle part of an upper end of the first U-shaped round rod (52).

4. The movable folding handcart according to claim 3, wherein the main connecting assembly (6) comprises a pushing mechanism (61) and support mechanisms (62) movably mounted on two sides of a lower end of the pushing mechanism (61), a right-angle block (63) being movably mounted at a lower end of each of the support mechanisms (62), and a diagonal support rod (64) being movably mounted on one side of an upper end of the right-angle block (63).

5. The movable folding handcart according to claim 4, wherein the pushing mechanism (61) comprises a fifth U-shaped round rod (611), and first hollow round sleeve columns (612) fixedly mounted on two sides of a lower end of the fifth U-shaped round rod (611), a first half-section circular block (613) being integrally formed at a lower end of each of the first hollow round sleeve columns (612), and an insertion rod (614) being fixedly mounted at a middle part of an inner cavity of the first half-section circular block (613).

6. The movable folding handcart according to claim 5, wherein each of the support mechanisms (62) comprises a long rod (621) and a second hollow round sleeve column (622) fixedly mounted at one end of the long rod (621), a corresponding half-section circular block (623) being fixedly mounted at one end of the second hollow round sleeve column (622), and a circular annular groove (624) being mounted at a middle part of an inner cavity of the corresponding half-section circular block (623).

7. The movable folding handcart according to claim 6, wherein the driven assembly (7) comprises a fourth U-shaped round rod (71) and a sixth U-shaped round rod (72) movably mounted on two sides of one end of the fourth U-shaped round rod (71), convex blocks (73) being movably mounted on two sides of a lower end of the sixth U-shaped round rod (72), and a second hollow clamping block (74) being fixedly mounted at a middle part of one end of the fourth U-shaped round rod (71).
